(19) United States
(12) Patent Application Publication
(10) Pub. No.: US 2009/0130327 A1
(43) Pub. Date: May 21, 2009

(54) Method for Repairing a Damaged Outer Skin Region on an Aircraft

(75) Inventors: Wolfgang Erdmanm, Buxtehude (DE); Eckehard Zundorf, Neunkirchen-Seelscheid (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 12/227,664

(22) PCT Filed: May 26, 2006
(86) PCT No.: PCT/EP2006/005054

§ 371 Date: Nov. 24, 2008

(51) Int. Cl. B01J 19/08

(52) U.S. Cl. 427/457; 427/140

(57) ABSTRACT

A method for repairing a damaged outer skin region on an aircraft, in which the possibility exists for repairing possible damage to a plated layer, which is adhered to the outer skin of a passenger aircraft and protects the latter in the undamaged state from corrosion. With the method, the plated layer can be repeated in the area of existing damage without incidental reworking.

### FIELD OF THE INVENTION

The invention relates to a method for repairing a damaged outer skin region on an aircraft.

### TECHNOLOGICAL BACKGROUND

With the industrially proven method variation of thermal spraying, the so-called “cold-gas spraying”, the possibility exists of applying metal powder particles with supersonic speed onto a surface. The cold-gas spray relates to a coating technique, in which a material is not fused or melted on, in contrast to other spraying methods. The powder particles are accelerated in a heated gas flow to a predetermined particle speed and form a dense and adhesive layer upon impacting the substrate, based on its high kinetic energy. One may spray layers as well as thicker structures, for example, form pieces, with the method. In comparison to thermal spraying methods, the cold-gas spraying may be suited especially for spraying a coating of oxidation-sensitive materials.

### SUMMARY OF THE INVENTION

It is an object of the present invention to provide a solution for repairing a damaged layer on the outer skin of an aircraft, which takes into account the coating technology “cold-gas spraying” and which may be implemented without particular manual expense and without hull-damaging amounts in an environmentally friendly manner.

According to an exemplary embodiment of the present invention, a method for repairing a damaged outer skin region on an aircraft is provided, wherein the repair of a damage point takes place by using a coating technique, the method comprising the following steps:

a) directing, at constant distance (x), the pistol outlet to an application point, the application point being integrated in the damage point, and then
b) flowing a carrier gas through a second pistol-loading channel, the carrier gas being provided on a second pistol inlet and having a temperature of approximately 100° C., which is performed in a controlled manner by the second pistol-loading channel, and next
c) flowing the carrier gas into the pistol-port channel, which because of the gas flow at the outlet of a first pistol-loading channel, produces a vacuum, then
d) flowing multiple aluminum-like powder particles, whose supply occurs at a first pistol input, through a first pistol-loading channel, which are suctioned as a result of a produced vacuum,
e) conducting the particles into the pistol-port channel and taking the particles by the gas flow of the carrier gas, thereupon
f) combining the detected powder particles with the gas flow of the carrier gas to a powder-particle-gas mixture, which flows through the pistol-port channel with a gas-particle speed (V_{P}), which lies between 500 m/s and 1000 m/s, and is released at the pistol outlet and is impinged on a substrate on the application point,
g) impinging of the powder particle-gas mixture on a substrate on the application point, such that upon impingement of the powder particles of the powder particle-gas mixture on the substrate, due to the kinetic energy of the particles at the application point, an adherent aluminum-like adhesion is implemented approximately in a punctiform manner or with a flat application,
h) spreading the adhesion to an aluminum-like layer as a result of a surface distributed movement of the pistol outlet over the area of the damage point, the movement extending over the damage point, until
i) the damage point is equalized with the aluminum-like layer, characterized by the following features, according to which
a particle composite of the aluminum-like powder particles is used with an approximately pure aluminum, which has a 90% to approximately 100% part aluminum,
the aluminum-like layer with multiple, uniformly-realized and adjacent aluminum-like aggregates is realized to a particle-dense and adhesive substrate-application, and
the distance (x), which is varied as a function of the dimensions of the surface to be repaired of the damage point, is tolerated from 6 cm to 30 cm, such that
a post-treatment time of the damage point because of insufficient adhering of the aluminum layer on the substrate is eliminated.

According to another exemplary embodiment of the present invention, the damage is related to localized damage points on a plated layer, the plated layer being applied on an outer skin and adapted for protecting the outer skin from corrosive damage, wherein the coating technique comprises cold-gas spraying with a cold-gas pistol, wherein the pistol has an internal structure including two inlet-side connected pistol-loading channels, which open into a pistol-port channel, which is arranged within a pistol barrel and is connected to a pistol outlet.

According to another exemplary embodiment of the present invention, the aluminum-like layer is realized according to step i) with a layer thickness of 0.01 mm to 5 mm.

According to another exemplary embodiment of the present invention, the aluminum-like powder particles of step d) are supplied with a particle size of 2 μm to 500 μm.

According to another exemplary embodiment of the present invention, the post-treatment time of the damage point is limited only to an aerodynamic compensation of the aluminum layer with the outer skin region of the aircraft, which is implemented by contraction of a coated aluminum-layer region that is not planar with the outer skin by grinding of the excess aluminum-layer region.

According to another exemplary embodiment of the present invention, for compensation of the damage point, at least one or more aluminum-like layers are applied, which comprise a very small oxide portion and are adhered more densely than light-diffracting sprayed layers on the substrate.

According to another exemplary embodiment of the present invention, the method is be used for an appropriate repair of damaged regions on plated aircraft skin sheets, preferably for rebuilding of plated layers that protect from corrosion, for filling depressions and/or dents, for reinforcement of a damaged region with gradual transitions to undamaged regions, and for closing sources of cracks.

According to another exemplary embodiment of the present invention, the method is adapted for removing of all damages, whose appearance of damage is indicated by depressions on the outer skin of the aircraft, which preferably are visible by the effect of scratching.

According to an aspect of the present invention, a method is provided which may allow for repairing possible damage to a plated layer, which is adhered to the outer skin of a passenger aircraft and protects the latter in the undamaged state from corrosion. With it, the plated layer can be repeated in the area of existing damage without incidental reworking.

The use of a cold-gas spray technology for aircraft construction as well as corresponding specifications, which relate to technical process parameters to be observed, are not known from publications or in any other manner.

In contrast, with the structural assembly of a passenger aircraft, through error of different causes, damage to the outer skin, that is, damage to the layer application of the aircraft outer skin, may be observed. These errors may not be covered by cosmetic features and remain, therefore, with the running of a passenger aircraft, quite visible to the customer. Often, with damage in the form of scratches, the plated layer of pure aluminum that protects from corrosion is penetrated, which may lead to a substantial shortening of the longevity of the related aircraft component by corrosion. A treatment by sanding may expose further unplated components of the outer skin, as can be seen from attached FIG. 1. Therefore, a corresponding need exists in aircraft construction, to enable repair of outer skin damages, which appear in the form of scratches or dents or other caused destruction, subsequently with a quality layer-application.

### SHORT DESCRIPTION OF THE DRAWINGS

The invention is described in greater detail below with reference to an exemplary embodiment shown in the accompanying drawings. In the drawings:

FIG. 1 shows damage (scratch) treated by sanding in a plated layer adhered to the outer skin of an aircraft;

FIG. 2 shows the arrangement for performing the repair of a damage point of the plated layer with a cold-gas pistol.

### DETAILED DESCRIPTION OF EXEMPLARY EMBODIMENTS

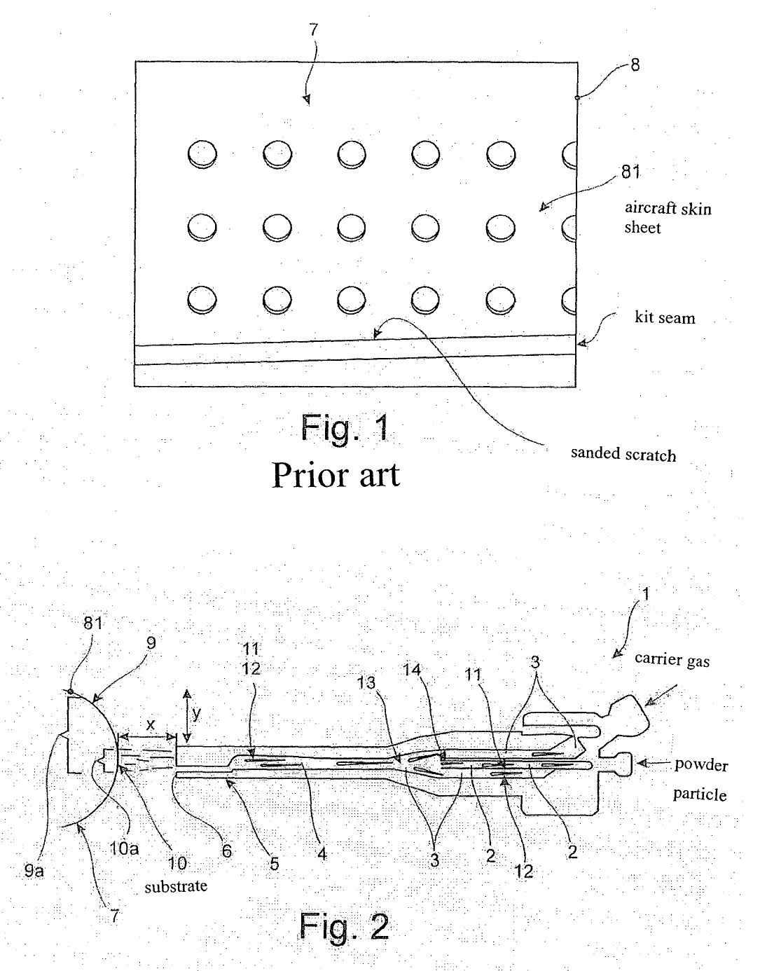

In FIG. 1, which is initially relied upon for better understanding of the invention, a coated aircraft skin sheet is shown (in plan view), which during the structural assembly (always for these reasons), a scratch is made on the plated layer 7. This damage point 9 on the outer skin 8 of a (here) passenger aircraft could be corrected only by sanding of the scratch. After completion of the repair, the plated layer 7 that protects from corrosion is grinded by a corresponding penetrating application. The unattractive appearance of the sanded scratch generally remains after the final lacquering of the aircraft, and therefore also is visible by the customers.

A better repair possibility for repairing a damaged outer skin region on an aircraft can be implemented by using the known coating technology “cold-gas praying”, provided that the (subsequently described) technological specifications are adhered to in a disciplined manner. With this technology, whose modification (with each method described below) is made of interest for aircraft construction, the possibility exists for completing repair of damaged regions of plated aircraft skin sheets properly and with quality without particular expense. All criteria, which are relevant for a proper repair of a damaged outer skin region are implemented, of which
the rebuilding of the plated layer that protects from corrosion,
filling of depressions/dents by a functional layer (with cosmetic considerations),
the reinforcement of the damaged region with easy transitions to undamaged regions,
closing of the cracks
   are to be considered.

A central repair, which is concerned with stopping the noted deficiencies according to the previously described method, would help prevent the occurrence of construction deviations, which are provided based on a permeated plated layer (according to the traditional repair methods), or at least limit them to a minimum.

According to an exemplary embodiment of the present invention, a method is provided, which may be used when damage of the outer skin region of an aircraft exists, which relates to localized (fixed) damage points 9 on the plated layer 7. The latter is fixedly applied on the outer skin 8 of the aircraft, which is exposed permanently to the effects of the aircraft surrounding environment for protection of any corrosive damage. If the repair of a damage point 9 according to FIG. 2 is necessary, a repair technology for repairing damaged outer skin regions on the aircraft is proposed, which deviates from traditionally used technologies. It is proposed to repair this damage point 9 by a modified use of the known coating technology “cold-gas spraying” with a cold-gas pistol 1. The cold-gas pistol 1 is equipped internally with first and second pistol-loading channels 2, 3, which are connected respectively with a pistol inlet. The first pistol-loading channel 2 is coated externally with powder particles 11, which are suctioned trough this channel as a result of a channel-outlet-side acting vacuum, which will be described in more detail below. The second pistol-loading channel 3 is supplied with a gas that is under pressure (as a carrier gas 10 for the power particles 11), which is pressed through this channel. Both channels 2, 3 are connected to an internally disposed pistol-port channel 4, into which both channels 2, 3 open. The pistol-port channel 4 is connected to a pistol outlet 6, which is retained in the direction of this outlet in a (approximately) horizontal orientation within a pistol barrel 5. This design of a cold-gas pistol 1 suited as a spraying pistol, which finds corresponding consideration in cold-gas spraying, is generally known among experts.

However, according to an aspect of the invention, the method, which can be used for repairing a damaged outer skin region, whose damaged plated layer 7 is to actually protect the aircraft structure from contemplated corrosion, comprises a modification, which relates to each subsequently described method step and may be used in aircraft construction. A series of tests that were performed eliminated any existing doubts with regard to the result of the exemplary embodiment.

With each (representation of an) arrangement (in a side view) according to FIG. 2 for performing the repair of a damage point of the plated layer 7, which is adhered to the outer skin 8 of the aircraft to provide protection from corrosion (again reconstructed), for example on an aircraft skin sheet, the possibility exists of technologically implementing the following steps (in the provided sequence). First (as simple as it also may appear), the pistol outlet 6 of each (previously described) cold-gas pistol 1 is directed to an application point 10, without permitting a release of gas movement thought the second pistol-loading channel 3, that is, through the pistol-port channel 4. A corresponding safety on the pistol, which is located in the secured state, is supplied during this handling for this purpose. Then, the cold-gas pistol 1, respectively the pistol barrel 5 (the pistol outlet 6) is directed onto the damage point 9 in a technologically prescribed distance x of constant length (if needed, with the support of a suitable pivoting or drivable support for holding the pistol).

Each embodiment is defined, such that in FIG. 2, such a damage point 9 of a damaged plated layer 7, which is adhered for example to a (here) inwardly bent aircraft skin sheet 81, on each bent sheet region of the aircraft skin sheet 81 that is referenced, is defined by a first clamp 9a. Since each damage point 9 possibly has multiple application points 10 for application of the sprayed material, a larger surface damage of the plated layer 7 exists, and in FIG. 2, at least one single application point 10 is shown, which is vertically limited on each bent sheet region of the aircraft skin sheet 81 by a second clamp 10a.

Depending on the surface of the damage point 9 to be repaired, the distance x (shown in FIG. 2) should be from 1 cm (with a small-surface damage region) up to 30 cm (with a large-surface damage region).

With regard to other features to be noted, which correlate with the definition of the distance x to be selected, the provided pressure of the supplied gas and the (adjustable or contant) nozzle shape of the pistol-port channel 4 on the pistol outlet 6 are to be noted, which effect the (wide- or narrow-surface or (approximately) punctiform) aggregate (design) of the sprayed material-application (of the coated powder particle application) on the damage point 9 or the application point 10.

With regard to each predefined end position of the cold-gas pistol 1, the securing of the gas supply to the cold-gas pistol 1 is eliminated, whereupon the (now designated) carrier gas 12 is flowed through a second pistol-loading channel 3 in a controlled manner, which after entry into the pistol-port channel 4 at the outlet 14 of the first pistol-loading channel 2, produces a respective vacuum (initial), by means of which suctioning of each available powder particle 11 through the first pistol-loading channel 2 occurs. Under these conditions, it is ensured that a controlled supply of multiple (dust-like) powder particles 11 of aluminum flowing through the first pistol-loading channel 2 takes place as well as a flowing through of the second pistol-loading channel 3 of the carrier gas 12, which has a temperature of approximately 100° C. Thereafter, the gas flow of the carrier gas 12, which is introduced at the outlet 13 of the second pistol-loading channel 3 into the pistol-port channel 4, the powder particles 11 are detected and absorbed from each powder particle flow, which then are combined with the gas flow, with a gas-particle speed V_{P} that lies between 500 m/s and 1000 m/s, leaves the pistol outlet 6 and is impinged onto a substrate on the application point 10, wherefore then upon impingement of the powder particles 11 onto the substrate, based on a higher kinetic energy of each powder particle 11 on the application point 10, for example in an approximate punctiform manner, an adhesive aluminum aggregate is applied. Then, if necessary, the adhered aluminum aggregate is applied as a particle-dense and adhesive substrate-application with an aluminum layer, which closes the damage point 9, as a result of a surface-distributed movement of the pistol outlet 6 over the area of the damage point 9 with additional (multiple) adjacent aluminum aggregates, which also are implemented according to the above-described steps. These features are implemented until the damage point 9 is evened out with the aluminum layer.

Each of the above-described features, according to which the proposed method for repairing a damaged outer skin region on an aircraft should be performed, are defined with further embodiments of these features. Thus, upon performing of the method, it should be taken into consideration that the noted aluminum layer, with which the damage point 9 is equalized, can be realized with a layer thickness of 0.01 mm to 5 mm.

The size of the dust-like powder particles 11 made from aluminum, which are supplied to the cold-gas pistol 1 and conducted through the channels 2, 4, and which leave the pistol outlet 6, are 2 μm to 500 μm. In addition, one should note that the temperature of the carrier gas 12, which is introduced into the second pistol-loading channel 3, has a temperature between 50° C. and 150° C.

The method can be performed with an inert carrier gas 12, since other carrier gases that are useable for the powder particles 11 flowing with it, whose transport through the pistol-port channel 4 can be realized with the flow medium “gas” as the carrier (first), are not excluded. Thus, one would not expect any problems for example with a carrier gas that is available a (normal) compressed air.

As already explained, the powder particles 11 used have a particle composition with pure aluminum or almost pure aluminum. Thus, the particle composition of each powder particle 11 has a 90% to 100% portion of aluminum, whereby a use of powder particles, which can be realized with a preparation of dust-like particles from an aluminum alloy or another adhesive particle-component on the basis of an aluminum material, which can be fixedly adhered to the substrate, is not excluded.

A post-treatment time of the damage point 9 because of insufficient adhesion of the aluminum layer on the substrate is eliminated. A post-treatment of the damage point 9 is limited only to an aerodynamic leveling of the aluminum layer with the outer skin region of the aircraft, which is implemented by contraction of a coated aluminum layer region that is not planar to the outer skin 8 by sanding of the excess aluminum layer region.

Also, for equalizing the damage point 9, at least one (however also possibly more) aluminum layers can be applied, which are designated by a very minimal oxide portion and are adhered more densely as light-diffracting layers on the substrate.

Also, it should be noted that the outer skin 8 is heated during the performance of the method to not over 70° C.

The method explained above is used for a proper repair of damaged regions on plated aircraft-skin sheets, preferably for reconstruction of the plated layer 7 that protects from corrosion, for filling depressions and/or dents, for reinforcement of a damaged region with easy transition to undamaged regions, as well as for closing cracks.

Also, a use for eliminating all such damage is contemplated, whose type of damage is permeated depressions on the outer skin 8 of the aircraft, preferably visible by the affects of scratching.

In conclusion, a repair technology is proposed, which is suitable for repairing a damaged plated layer, whose surface-covering application should protect a metal structure from damaging corrosion. Upon spraying of pure aluminum according to the proposed method, which can be realized with each assembly of FIG. 2, the damage point of each plated layer is filled with at least one repair layer, as long as technologically prescribed processes and conditions are adhered to, at least at layer thickness of between 10 μm and 5 mm (or, with multiple layers placed on one another, still thicker layer thicknesses) can be realized. The layers applied according to these steps have a very minimal oxide portion and are applied more densely as light-diffracting layers.

A (central) repair of the damaged outer skin region (specialized) of a passenger aircraft according to the technology provided signifies time savings as well as the elimination of construction deviations, compared with common repair methods, which are employed based on a permeated plated layer 7.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

Reference numeral list

| | |
|---|---|
| 1 | cold-gas pistol |
| 2 | pistol-loading channel, first |
| 3 | pistol-loading channel, second |
| 4 | pistol-port channel |
| 5 | pistol barrel |
| 6 | pistol outlet |
| 7 | plated layer |
| 8 | outer skin (of an aircraft) |
| 9 | damage point |
| 9a | first clamp, vertical containment |
| 10 | application point |
| 10a | second clamp, vertical containment |
| 11 | powder particle, dust-like |
| 12 | carrier gas; air, compressed air |
| 13 | outlet (of the second pistol-loading channel 3) |
| 14 | outlet (of the first pistol-loading channel 2) |
| 15 | pistol-inlet, first |
| 16 | pistol-outlet, second |
| x | distance (pistol-outlet 6 - application point 10) |
| y | movement direction (of the pistol-port channel 4) |
| V_{P} | gas-particle speed |

1. A method for repairing a damaged outer skin region on an aircraft, wherein the repair of a damage point takes place by using a coating technique, the method comprising:
a) directing, at constant distance, a pistol outlet to an application point, the application point being integrated in the damage point,
b) flowing a carrier gas through a second pistol-loading channel, the carrier gas being provided on a second pistol inlet and having a temperature of approximately 100° C., which is performed in a controlled manner by the second pistol-loading channel,
c) flowing the carrier gas into the pistol-port channel, which because of the gas flow at the outlet of a first pistol-loading channel, produces a vacuum,
d) flowing multiple aluminum-like powder particles, whose supply occurs at a first pistol input, through a first pistol-loading channel, which are suctioned as a result of a produced vacuum,
e) conducting the particles into the pistol-port channel and taking the particles by the gas flow of the carrier gas,
f) combining the detected powder particles with the gas flow of the carrier gas to a powder-particle-gas mixture, which flows through the pistol-port channel with a gas-particle speed (V_{P}), which lies between 500 m/s and 1000 m/s, and is released at the pistol outlet and is impinged on a substrate on the application point,
g) impinging the powder particle-gas mixture on a substrate on the application point, such that upon impingement of the powder particles of the powder particle-gas mixture on the substrate, due to the kinetic energy of the particles at the application point, an adherent aluminum-like adhesion is implemented approximately in a punctiform manner or with a flat application,
h) spreading the adhesion to an aluminum-like layer as a result of a surface distributed movement of the pistol outlet over the area of the damage point, the movement extending over the damage point, until
i) the damage point is equalized with the aluminum-like layer, comprising the following features, according to which
a particle composite of the aluminum-like powder particles is used with an approximately pure aluminum, which has a 90% to approximately 100% part aluminum,
the aluminum-like layer with multiple, uniformly-realized and adjacent aluminum-like aggregates is realized to a particle-dense and adhesive substrate-application, and
the distance, which is varied as a function of the dimensions of the surface to be repaired of the damage point, is tolerated from 6 cm to 30 cm, such that
a post-treatment time of the damage point because of insufficient adhering of the aluminum layer on the substrate is eliminated.

2. The method of claim 1,
wherein the damage is related to localized damage points on a plated layer, the plated layer being applied on an outer skin and adapted for protecting the outer skin from corrosive damage;
wherein the coating technique comprises cold-gas spraying with a cold-gas pistol; and
wherein the pistol has an internal structure including two inlet-side connected pistol-loading channels, which open into a pistol-port channel, which is arranged within a pistol barrel and is connected to a pistol outlet.

3. The method of claim 1, wherein the aluminum-like layer is formed according to step i) with a layer thickness of 0.01 mm to 5 mm.

4. The method of claim 1, wherein the aluminum-like powder particles of step d) are supplied with a particle size of 2 μm to 500 μm.

5. The method of claim 1, wherein the post-treatment time of the damage point is limited only to an aerodynamic compensation of the aluminum layer with the outer skin region of the aircraft, which is implemented by contraction of a coated aluminum-layer region that is not planar with the outer skin by grinding of the excess aluminum-layer region.

6. The method of claim 1, wherein for compensation of the damage point, at least one or more aluminum-like layers are applied, which comprise a very small oxide portion and are adhered more densely than light-diffracting sprayed layers on the substrate.

7. The method of claim 1, further comprising repairing damaged regions on plated aircraft skin sheets for at least one of rebuilding of plated layers that protect from corrosion, filling depressions and/or dents, reinforcement of a damaged region with gradual transitions to undamaged regions, and closing sources of cracks.

8. The method of claim 7, further comprising removing all appearance of damage indicated by depressions on the outer skin of the aircraft, which are visible by the effect of scratching.
